(19) United States
(12) Patent Application Publication
(10) Pub. No.: US 2007/0294947 A1
(43) Pub. Date: Dec. 27, 2007

(54) Cassette For Force Transmission In A Window Winder

(76) Inventor: Frank Fassbender, Coburg (DE)

Correspondence Address: CHRISTIE, PARKER & HALE, LLP, PO BOX 7068, PASADENA, CA, 91109-7068, US

(21) Appl. No.: 10/592,545

(22) PCT Filed: Mar. 3, 2005
(86) PCT No.: PCT/DE05/00415

§ 371 Date: Jul. 3, 2007

(30) Foreign Application Priority Data
Mar. 12, 2004 (DE) 2004 004 044.1

(51) Int. Cl. E05F 11/38

(52) U.S. Cl. 49/227

(57) ABSTRACT

A cassette for force transmission in a window winder, with fitting means for fitting at least one force-introducing means on the cassette. The fitting means have a passage opening which completely penetrates the cassette from a first cassette side to a second cassette side and the force-introducing means, which is passed through the passage opening, can be fitted on the cassette by the fitting means.

### CROSS-REFERENCE TO A RELATED APPLICATION

This application is a National Phase Patent Application of International Patent Application Number PCT/DE2005/000415, filed on Mar. 03, 2005, which claims priority of German Patent Application Number 20 2004 004 044.1, filed on Mar. 12, 2004.

### BACKGROUND

The invention relates to a cassette for force transmission in a window winder and to a driver and to a window winder.

Various types of window winders have been proposed and used in practice to move a window between a closed and an open position. The opening and closing movement of the window is usually guided along a guide track or rail. Track-controlled window winders of this type are used in particular in motor vehicles. In this case, the guide tracks and at least parts of the window are located within a motor vehicle door.

In order to be able to guide the window during its opening and closing movement along the guide rail, the window is connected either directly or via a support plate to fastening means in the form of a stepped bolt which, in turn, is connected to sliders which move along the guide rail. The slider is usually only moveable along the guide rail, for which reason the movement of the window takes place only along the track determined by the guide rails.

A cassette which serves for the fitting of the force-introducing means, such as, for example, cable pulls, is connected to the slider. Depending on the type of slider, the shape of the cassette can be of greatly differing and complex design and can have rounded portions, surfaces and corners.

For the fitting of the force-introducing means, the cassette has fitting means which are designed differently in the prior art for cable pulls as force-introducing means.

DE 34 45 00 discloses a cassette in which a cable pull nipple is fitted on a cable pull, which cable pull nipple is wider than the cable pull diameter and is formed at that end of the cable pull which is to be fitted on the cassette. The cable pull nipple is connected fixedly to the cable pull and is inserted into a nipple chamber let into the cassette. A channel into which the cable pull is placed and which is too narrow to receive the cable pull nipple leads away from the nipple chamber. The channel is open toward one cassette side, for which reason the cable pull, when being fitted, is simply placed into the channel. The nipple chamber is then closed by a closure cover. If a tensile force acts on the cable pull, then the cable pull nipple remains in the nipple chamber, since it does not fit through the channel and is prevented by the closure cover from leaving the nipple chamber. The tensile force is therefore transmitted to the cassette by the cable pull.

A further known type of fitting means likewise comprises a nipple chamber and a closed channel. Only a cable pull without a nipple can be inserted through the channel, since, apart from a free, tubular tunnel and two end openings for the cable pull, the channel is closed. To fit the cable pull, the latter has first of all to be threaded into the channel and subsequently passed through it. The cable pull is then pressed together with a cable pull nipple.

### SUMMARY

It is the object of the present invention to provide an improved possibility for transmitting forces of a window winder via a driver to a window.

The cassette has fitting means for fitting at least one force introducing means on the cassette. The solution according to the invention is distinguished in that the fitting means comprise a passage opening which completely penetrates the cassette from a first cassette side to a second cassette side. The force-introducing means, which is passed through the passage opening, can be fitted on the cassette by the fitting means.

For installation, the force-introducing means is passed completely through the passage opening from the first cassette side to the second cassette side and is fastened in this position. As a result, the force-introducing means is not separated from the cassette in the pre-installation position by a force acting on the cassette via the force-introducing means. The passing of the force-introducing means through the passage opening improves the fastening of the force-introducing means to the cassette, in particular since, in the pre-installation position, the cassette is not yet fastened and its position relative to the force-introducing means is therefore not fixed. Forces acting from the force-introducing means can therefore act on the cassette from a plurality of directions, depending on the relative position of the cassette. To release the fastening, the force-introducing means has to be completely removed from the passage opening. As a result, a force-introducing means inserted into the passage opening is particularly readily protected from tensile forces from different directions. If the cassette is ready-installed in an operating position and if a connection to the window is produced, then the displacement forces act from one or more known directions, for which reason the loading of the cassette is precisely determined.

It is therefore precisely during the installation of the individual components of the window winder that the special fastening with a passage opening as fitting means brings about a particularly good fastening of the force-introducing means to the cassette.

The cassette can have any desired shape which serves to pass on displacement forces from a window winder mechanism in such a manner that a window is displaced in its position.

The first and the second cassette sides are preferably formed essentially perpendicular to a direction in which the force-introducing means, which is fitted on the cassette, is guided away from the cassette and in which forces of a window winder mechanism, which forces act on the cassette via the force-introducing means, act.

In this case, the expression “essentially perpendicular” is to be understood as meaning that the angles between the first and the second cassette side, the cassette sides, are designed to be as large as possible. The third cassette side is therefore formed at right angles to the two sides. Cassettes are usually not of exactly cuboidal design but a shape similar to a cube can be seen which possibly has a very complex arrangement with a multiplicity of rounded portions, surfaces, corners and projections, for which reason the assignment of a right-angled direction cannot always take place exactly.

The first cassette side particularly preferably lies opposite the second cassette side, with the passage opening penetrating these two cassette sides essentially perpendicularly. Forces of a window winder mechanism, which forces are introduced via the force-introducing means, therefore bear at least partially on two opposite cassette sides and thus ensure that the cassette is loaded as uniformly as possible.

In one embodiment, a cutout for receiving the force-introducing means is formed in the first cassette side. The cutout connects the passage opening to a third cassette side from which a force-introducing means, which is fitted on the cassette, leads away from the cassette.

The fitting means advantageously have two passage openings and are designed for receiving two force-introducing means. In this case, the fitting means are preferably arranged in such a manner that two force-introducing means, which are fitted on them, point away from the cassette in two opposite directions and the introduction of force preferably takes place by means of a tensile force which is dependent on the displacement direction, for example one force-introducing means for a closing movement of a window and one for an opening movement of a window.

In one embodiment, the cassette is designed in such a manner that a force-removing means can be fitted on the cassette, with forces which are introduced into the cassette via the force-introducing means being transmittable to a support plate of a window by the force-removing means. In this case, the force-removing means can advantageously be fitted on an insertion opening of the cassette. Support plate is to be understood as meaning any means for the fitting of a window, for example the force-removing means may also be connected directly to the window, and not only indirectly via a support plate.

The cassette particularly preferably comprises the fitting means and is designed as a single part. The fitting means are therefore part of the cassette, for example are in the form of cutouts and projections, and do not have to be fitted separately. The cassette is not composed of individual parts but rather of a single part, including the fitting means. In particular, an embodiment of the cassette as a plastic molded part or as an aluminum injection molding is preferred.

The fitting means of the cassette are advantageously designed in such a manner that either a cable pull, a wire pull, a dimensionally stable pushing means or a Bowden cable can be used as the force-introducing means. A combination of a plurality of different force-introducing means can also be realized, or an embodiment of the fitting means which can be used for a plurality of different force-introducing means.

In one embodiment, an interlocking and/or frictional connection can be provided between the cassette and the force-introducing means by the fitting means. An interlocking connection by contact of the force-introducing means with the cassette is particularly preferably produced.

For this, it is advantageously provided that the fitting means have a channel for receiving the force-introducing means, with the extents of the channel being too small to receive a nipple of the force-introducing means, which nipple is designed to be wider than a diameter of the force-introducing means. In the event of a pull on the force-introducing means, the nipple serves to prevent the force-introducing means from slipping out of the passage opening. The nipple abuts against the channel and cannot be pulled through the channel, i.e. transmits the tensile force on the force-introducing means to the channel and therefore to the cassette.

In this case, the fitting means advantageously have a nipple chamber, which is adjacent to a first end of the channel, for receiving the nipple, with channel and nipple chamber being formed on the same cassette side, in particular the second cassette side. The force-introducing means can be laid from the passage opening to a second end of the channel or is directly adjacent to the latter. This saves space on the cassette surface, and, after passing through the passage opening, the force-introducing means can be laid at the same time into the channel and the adjacent nipple chamber, which constitutes a particularly simple fitting possibility.

The nipple chamber preferably has a flange which impedes the nipple from coming out of the nipple chamber. The flange is designed in such a manner that although it does not prevent the force-introducing means from being fitted in the nipple chamber, it at least impedes, if not totally prevents, the nipple from coming out. This can be realized, for example, by means of a shape which is flattened in the insertion direction and is provided with an edge in the outlet direction. The flange therefore constitutes an additional means of securing the force-introducing means on the cassette.

The object is likewise achieved by a driver of a track-controlled window winder mechanism which has a slider and a cassette according to the invention which is operatively connected to the slider.

In this case, the driver preferably has a force-removing means, in particular a stepped bolt, on which the slider is fitted and by means of which forces acting on the cassette are transmitted to a support plate for a window which is to be moved.

A cassette which serves for the fitting of force-introducing means, such as, for example, cable pulls, is fitted on the slider. Slider with cassette together form a driver. The force-introducing means transmit a tensile force of a window winder mechanism to the cassette or the driver and, via the stepped bolt, to the support plate of the window. The stepped bolt therefore serves to transmit the tensile force from the driver to the support plate of the window.

In addition, the object is achieved by a window winder which has a driver according to the invention and a track. The track controls the displacement movement of the driver by means of the slider of the driver, which slider is arranged on the track. The window winder also has a force-introducing means for transmitting a force of a displacement drive of the window winder to the cassette of the driver.

In one embodiment, the force-introducing means is designed as a cable pull with a cable pull nipple, the cable pull being passed, with the cable pull nipple in front, through the passage opening of the cassette of the driver, being laid along a channel of the cassette, and the cable pull nipple being fitted in a nipple chamber of the cassette.

In this case, the cable pull nipple preferably has a spring mechanism which is fitted in the nipple chamber in such a manner that the spring force of the spring mechanism acts counter to a tensile force transmitted to the driver via the cable pull. As a result, the transmission of force is cushioned and protects the materials.

### BRIEF DESCRIPTION OF THE DRAWINGS

The invention is explained in more detail below using a number of exemplary embodiments with reference to the figures of the drawings, in which:

FIG. 1A shows a plan view of a schematically illustrated driver, comprising slider and cassette placed onto it, with a surrounding window winder mechanism.

FIG. 1B shows an enlarged plan view of the cassette of FIG. 1A which is placed onto the slider;

FIG. 2 shows a plan view of a cassette according to the invention which is fastened to a guide rail.

FIG. 3A shows a longitudinal section through a cassette, a slider and a fastening means and a window in a loose formation.

FIG. 3B shows a longitudinal section through a cassette, a slider and a fastening means and a window in a fitted position.

FIG. 3C shows an enlargement of the fastening means head from FIG. 3B.

FIGS. 4A-4D show the fitting of a cable pull on a cassette according to the invention in a schematic illustration.

FIGS. 5A and 5B show a schematic illustration of a cassette with two cable pulls fitted on it and the course thereof in the cassette.

### DETAILED DESCRIPTION

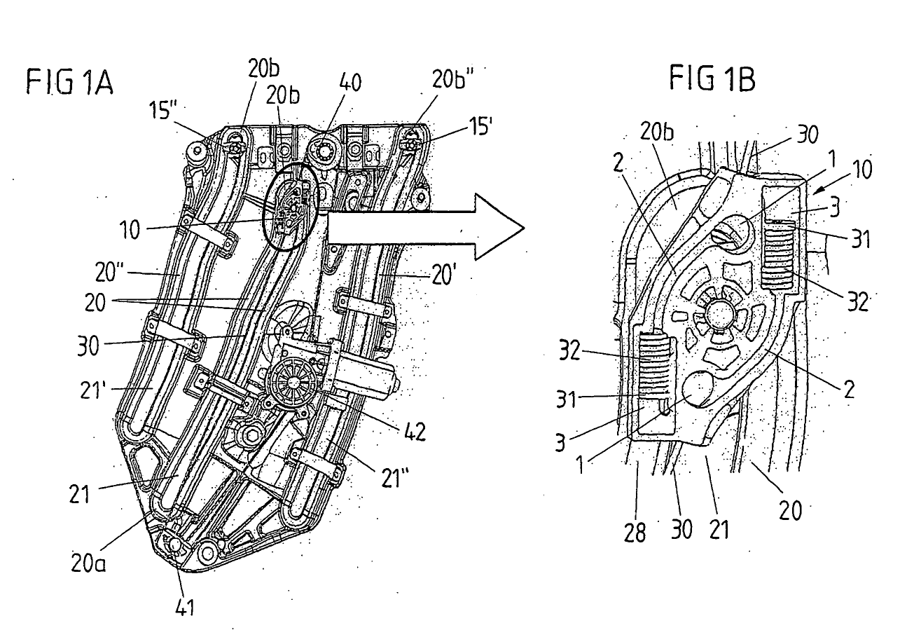

FIG. 1A shows, in a schematic illustration, devices which are fitted in a motor vehicle door and are intended for moving and guiding a window. Three guide rails or tracks 20, 20′, 20″ serve for the track-controlled movement of a window (not illustrated). The guide rails 20, 20′ and 20″ are in each case of two-part design and comprise two individual rails running essentially parallel to each other, thus forming guide-rail intermediate spaces 21, 21′and 21″.

Sliders 15′ and 15″ are fitted in the guide-rail intermediate spaces 21′ and 21″ of the guide rails 20′ and 20″ in such a manner that they can be moved only along these guide rails. A third slider in the guide-rail intermediate space 21 of the guide rail 20 is covered by a cassette 10 which is fastened on the slider (not visible in FIG. 1A).

All three sliders are fastened to a support plate (not illustrated) of the window and ensure that the window can be moved only along the direction of movement predetermined by the three guide rails 20, 20′ and 20″. If the sliders are located at the upper guide-rail ends 20b, 20b′ and 20b″, the window is closed and, if they are located at the lower guide-rail ends 20a, 20a′ and 20a″, the window is open.

Two cable pulls 30 are fitted on the cassette 10 as force-introducing means and are connected to the drive 42 via return pulleys 40 and 41. In this case, the return pulley 40 is fitted at the upper guide-rail end 20b while the return pulley 41 is fitted at the lower guide-rail end 20a. When a window winder actuating means (not illustrated) is actuated, the drive 42 exerts a tensile force on the cable pulls 30 which transmit the tensile force to the cassette 10 and move it in the direction of one of the return pulleys 40 or 41 and therefore in the direction of one of the guide-rail ends 20a or 20b. The tensile force is transmitted via the cassette 10 to the slider (not illustrated) arranged below it and to the support plate (not illustrated) and serves for the track-controlled movement of the window.

FIG. 1B illustrates the cassette of FIG. 1A in enlarged form. The cassette has two nipple chambers 3 which are designed as depressions in that side of the cassette 10 which is opposite the slider which is concealed in FIG. 1B, and in which a respective cable pull nipple 31 and a spring mechanism 32 are inserted. The cable pull nipples 31 and the spring mechanisms 32 are connected fixedly to in each case one end of a cable pull 30. The spring mechanisms are mounted in the nipple chambers 3 in such a manner that, by means of a pull along the cable pulls 30, a resulting tensile force is transmitted in a resilient manner to the cassette 10. The resilient mounting protects both the material of the cassette 10 and of the cable pulls 30 during the transmission of tensile forces to the cassette 10.

Ends of the channels 2, which are designed as elongate depressions in the cassette side, and through which the cable pulls 30 are laid, are adjacent to the nipple chambers 3. In this case, the channels 2 are so narrow that the cable pull nipples 31 and the spring mechanisms 32 cannot enter the channels 2, since they are designed to be too large for them.

At the other end of the channels 2, the cassette 10 has passage openings 1 through which the two cable pulls 30 run and which completely penetrate the cassette from the lower cassette side (not visible in the FIG.) to the upper, visible side.

The passage opening 1 is of rectilinear design and runs perpendicularly through the cassette 10. As an alternative, in another embodiment, the passage opening may also be of oblique or jagged design. Likewise, the passage opening can be designed such that it runs from the first to the second cassette side but after this such that it leads to a further cassette side.

A configuration according to the invention might also be conceivable without the nipple chambers and the channel if the force-introducing means is fastened directly in the passage opening, for example is clamped into place.

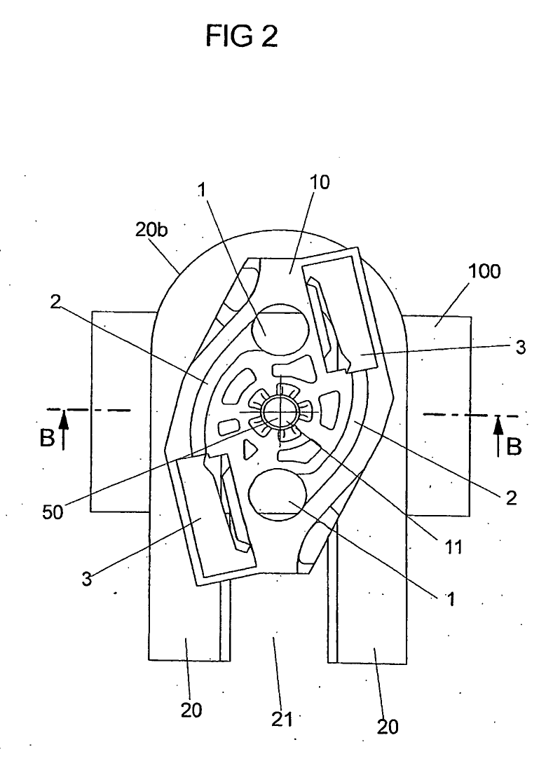

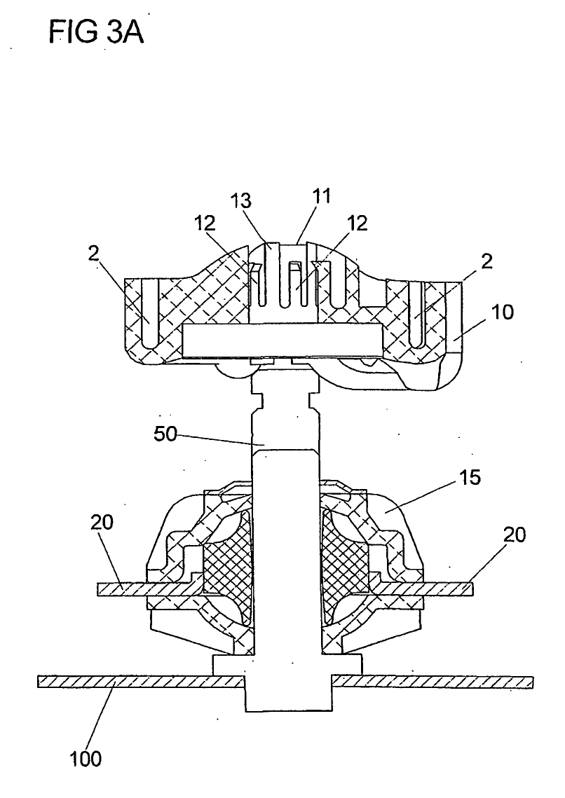

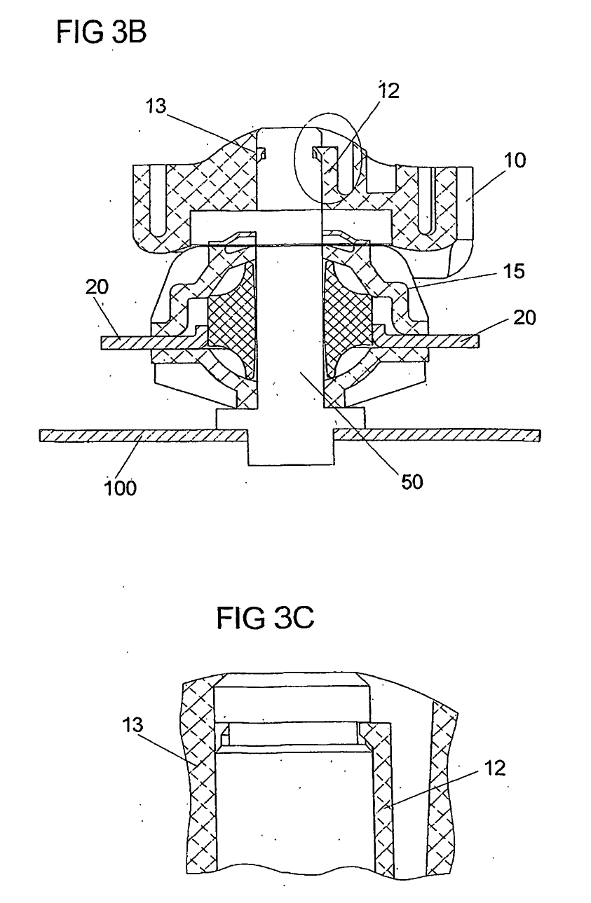

FIG. 2 shows a plan view of a cassette 10 which is illustrated in FIGS. 3A and 3B in a sectional illustration along the section plane indicated in FIG. 2 by the arrows B.

Before the installation of the cassette 10, a cassette 10 in the form of an individual part is present, as shown in FIG. 3A. The cassette 10 has an insertion opening 11 which, in FIG. 2, points into the plane of projection and through which the section plane of FIGS. 3A and 3B runs.

For its installation, the cassette 10 is plugged onto a fastening means 50 in the form of a stepped bolt, with the stepped bolt 50 being inserted into the insertion opening 11. The stepped bolt 50 is screwed or riveted to a support plate 100 which is connected frictionally to the window. Alternatively, the stepped bolt 50 can also be screwed or riveted directly to the window. The stepped bolt serves to transmit the displacement forces, which act on the cassette, to the window. Furthermore, FIGS. 3A and 3B show that a slider 15 is plugged onto the stepped bolt 50 which is penetrated by the stepped bolt 50. The slider 15 bears from two sides against a guide rail 20 which is likewise penetrated by the stepped bolt 50.

The fitting means are designed to be essentially point-symmetrical to an axis of symmetry of the cassette 10, which axis of symmetry runs along the stepped bolt 50. As a result, in particular, nipple chambers 3, channels 2 and passage openings 1 are point-symmetrical to one another and tensile forces on cable pulls 30 laid through them act on the cassette 10 from opposite directions. The cable pulls 30 point in opposite directions away from the cassette 10 to the return pulleys 40 and 41 positioned outside FIG. 1B.

FIG. 3B shows that the cassette 10 can be plugged onto that end of the stepped bolt 50 which lies opposite the window until the cassette 10 rests on the slider 15. Slider 15 and cassette 10 together form a driver.

FIG. 2 shows the cassette 10 at the guide-rail end 20B. The stepped bolt 50 runs through the intermediate space 21 perpendicular to the plane defined by the two parallel guide rails 20. Its one end is connected to the cutout of the support plate 100 (illustrated at the bottom in FIG. 2).

The slider 15 comprises the guide rail 20 and is itself held on the stepped bolt 50 between the cassette 10 and the support plate 100. The slider 15 itself is of multi-part design in a manner such that it can move in a plurality of spatial directions in order to be able to follow the complex track which is defined by the guide rails 20.

FIGS. 3A to 3C show that the cassette 10, along the insertion opening 11, has a plurality of resilient latching means 12 arranged concentrically with the insertion opening. If the cassette, as shown in FIG. 3B, is placed entirely onto the stepped bolt 50, then the latching means 12 latch into a latching groove of the stepped bolt 50 and fix the cassette in a locking position.

FIG. 3C illustrates this latching mechanism in enlarged form. The latching means 12 run essentially along the insertion opening 11. They have a latching lug which engages in a latching groove of the stepped bolt 50 and prevents a movement of the stepped bolt 50 counter to the plug-in direction by the fact that the latching lug strikes against a shoulder of the head of the stepped bolt 50.

If the cassette 10 is entirely plugged onto the stepped bolt 50, the latching means 12, when there is a pull on the stepped bolt 50, conduct pulling-off forces, which arise counter to the insertion direction, into the cassette 10 and therefore prevent the stepped bolt 50 from becoming detached from the cassette 10.

FIG. 2 shows that the cassette 10 has a total of five latching means 12 which are arranged concentrically with the insertion opening 11. Five bearing ribs 13 on which the stepped bolt 50 bears in the locking position are arranged between the latching lugs 12. Owing to the fact that the cassette in each case has five latching means and bearing ribs, a mounting which is as stable as possible is produced with as low a number of latching and bearing means as possible. However, a different number of latching means and bearing means can also be used in a fastening system according to the invention, in particular if the number of bearing means differs from the number of latching means.

The bearing ribs 13 run parallel to the stepped bolt 50 along the insertion opening 11. By means of the bearing ribs 13, rotational movements of the stepped bolt 50 with respect to the cassette 10 are prevented by the bearing ribs 13 bearing against a plurality of contact points of the stepped bolt 50 and thereby fixing it in place. Only a rotational movement about the insertion opening 11 remains possible.

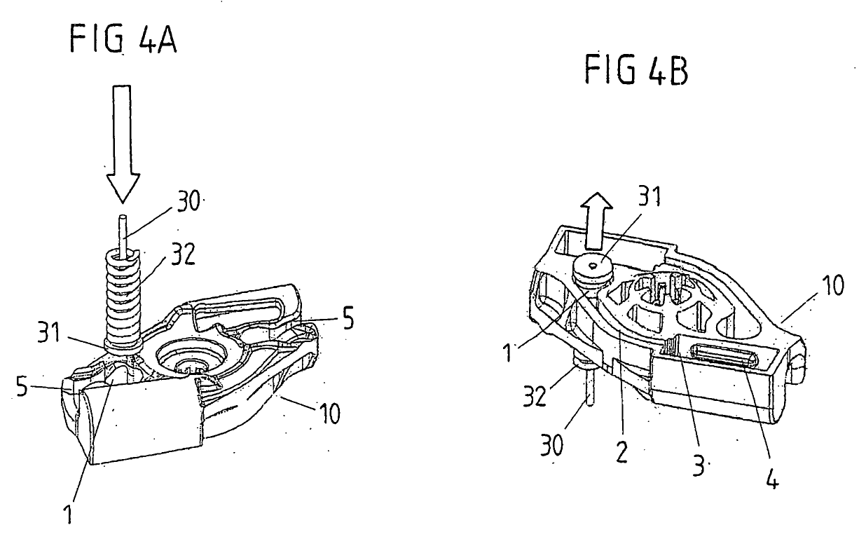

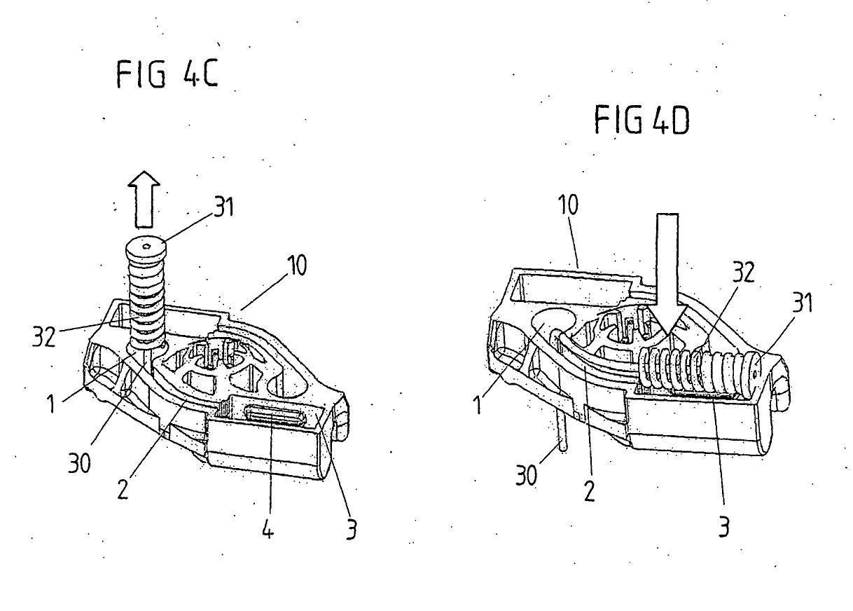

FIGS. 4A to 4D show, in a schematic illustration, a method as to how a cable pull 30, with a cable pull nipple 31 fitted to the cable pull end and a spring mechanism 32 adjoining said cable pull nipple, is fitted on a cassette 10.

In FIG. 4A, the cable pull 30, with the cable pull nipple 31 in front, is inserted in the arrow direction from the side into the passage opening 1 which, when installation is finished, bears on the slider 15. The passage opening 1 is designed in such a manner that the cable pull nipple 31 of the cable pull 30 can be passed completely through the passage opening 1.

FIG. 4B shows the opposite side of the cassette 10. The cable pull nipple 31 is completely plugged through the cassette 10 from a first cassette side to the opposite cassette side and is pulled out of the cassette 10 in the arrow direction to beyond the spring mechanism 32 (FIG. 4C). As a result, only the flexible wire of the cable pull 30 is located in the passage opening 1.

FIG. 4D shows how the cable pull nipple 31 is laid with the spring mechanism 32 into the nipple chamber 3. For this purpose, the cable pull 30 has been bent in such a manner that it runs away from the passage opening 1 through the channel 2 into the nipple chamber 3. The depressions in the cassette 10, which depressions form the channel 2 and the nipple chamber 3, are located on the cassette side toward which the cable pull 30 is plugged through the passage opening 1 during installation.

The spring mechanism 32 comprises a spiral spring, the spring of which is oriented in the direction away from the nipple chamber 3 to the channel 2. The spring is easily prestressed between cable pull nipple 31 and channel 2. The spring mechanism 32, the cable pull nipple 31 and the cable pull 30 are entirely recessed in the depressions. A flange 4 in the nipple chamber 3 ensures that the spring does not bend but rather runs parallel to the cassette side which has the depression for the nipple chamber 3.

In FIG. 4A, two cutouts 5 can be seen which run along the cassette side from which the cable pull 30 is inserted into the passage opening 1 during installation. The cutouts 5 serve to receive the cable pull part which is laid away from the passage opening 1 and the cassette 10.

The depth of these cutouts 5 and the depth of the cutouts which form the channels 2 and the nipple chambers 3 are coordinated with each other in such a manner that the cable pulls 30 runs without kinks and especially without a bend out of a plane parallel to the cassette sides which are penetrated by the passage opening 1.

During the installation of a complete driver, first of all the slider 15 is fitted on the guide rail 20 and then the cassette 10, which is already connected to the cable pulls 30, is plugged onto the stepped bolt 50 and therefore onto the slider 15.

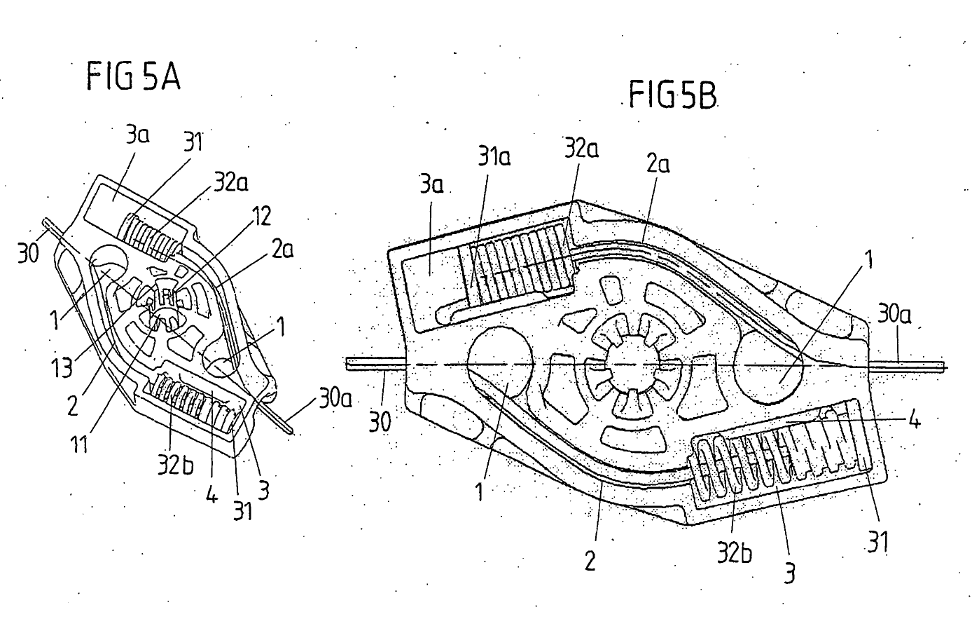

FIGS. 5A and 5B show a schematic illustration of the cassette 10 with two cable pulls 30 fitted on it, and the course thereof in the cassette 10. The two directions in which the cable pulls 30 point away from the cassette 10 are precisely opposed, which is made possible by means of a shaping of the cutouts 5 shown in FIG. 4A.

In FIGS. 5A and 5B, one spring mechanism 32b is relaxed, and another spring mechanism 32a is tensioned by a tensile force applied to the cable pull 30a. The tensile force pulls the cable pull nipple 31a to the channel 2a. The movement of the cable pull nipple 31a takes place entirely in the nipple chamber 3a, since the flange 4a prevents the spring 32a from bending and prevents the cable pull nipple 31a from coming out of the nipple chamber 3a. The small extent of the channel 2a prevents the cable pull nipple 31 from being pulled out of the nipple chamber 3 into the depression in the cassette side of the channel.

The spring mechanism 32a cushions the transmission of the tensile force to the cassette 10 and thereby prevents a severe wearing of the material, in particular a tearing of the cable pull 30a.

The cable pull nipple 31a is moved in the nipple chamber in the direction of the adjoining channel 2a along a spring path which is smaller than the compensating path covered by the cable pull 30a in the channel 2a. This avoids alternating bends in the cable.

Owing to the fact that the cable pull 30 is threaded through the cassette 10 from a first to a second cassette side, a tensile force acting on the cassette via the cable pull is applied to the first cassette side but the cable pull itself is laid further along the second cassette side. The cable pull is therefore not pulled out of the channel or the nipple chamber by tensile forces.

One advantage of this solution is that an additional and wear-susceptible fitting means, such as, for example, a closure cover, is not required but rather the shaping of the cassette 10 is sufficient by itself in order to provide sufficient fitting means.

A further advantage is that the cable pull 30 can be fitted on the cassette 10 at the same time as the cable pull nipple 31, i.e. the cable pull nipple 31 does not have to be connected first to the cable pull 30 after being threaded into and pushed through the channel 2, as in the prior art described at the beginning. The threading through the passage opening 1 is substantially simpler than the threading of the cable pull 30 without cable pull nipple 31 into the channel 2, since the passage opening 1 is wider.

The invention is not restricted to the embodiments illustrated in the drawings. For example, the cassette does not absolutely have to have the fitting means according to the invention for cable pulls but rather the slider may alternatively also have the fitting means.

1-25. (canceled)

26. A cassette for force transmission in a window winder, with fitting means for fitting at least one force-introducing means on the cassette, wherein
the fitting means have a passage opening which completely penetrates the cassette from a first cassette side to a second cassette side, and
the force-introducing means, which is passed through the passage opening, can be fitted on the cassette by the fitting means.

27. The cassette of claim 26, wherein the first and second cassette sides are formed essentially perpendicular to a direction in which the force-introducing means, which is fitted on the cassette, is guided away from the cassette and in which forces of a window winder mechanism, which forces act on the cassette via the force-introducing means, are applied.

28. The cassette of claim 26 or 27, wherein the first cassette side lies opposite the second cassette side, with the passage opening penetrating these two cassette sides essentially perpendicularly.

29. The cassette of claim 26, wherein the cassette has a cutout for receiving the force-introducing means in the first cassette side, which cutout connects the passage opening to a third cassette side from which a force-introducing means, which is fitted on the cassette, leads away from the cassette.

30. The cassette of claim 26, wherein the fitting means have two passage openings and are designed for receiving two force-introducing means.

31. The cassette of claim 30, wherein the fitting means are arranged in such a manner that two force-introducing means, which are fitted on them, point away from the cassette in two opposite directions.

32. The cassette of claim 26, wherein the cassette is designed in such a manner that a force-removing means can be fitted on the cassette, with forces which are introduced into the cassette via the force-introducing means being transmittable to a support plate of a window by the force-removing means.

33. The cassette of claim 32, wherein the force-removing means can be fitted on an insertion opening of the cassette.

34. The cassette of claim 26, wherein the cassette comprises the fitting means and is designed as a single part.

35. The cassette of claim 26, wherein the fitting means are designed to be essentially point-symmetrical to an axis of symmetry of the cassette.

36. The cassette of claim 26, wherein the fitting means of the cassette are designed in such a manner that a cable pull, a wire pull, a dimensionally stable pushing means and/or a Bowden cable can be used as the force-introducing means.

37. The cassette of claim 26, wherein an interlocking and/or frictional connection can be provided between the cassette and the force-introducing means by the fitting means.

38. The cassette of claim 26, wherein an interlocking connection can be provided between the force-introducing means and the cassette by contact of the force-introducing means with the cassette.

39. The cassette of claim 26, wherein the fitting means have a channel for receiving the force-introducing means, with the extents of the channel being too small to receive a nipple of the force-introducing means, which nipple is designed to be wider than a diameter of the force-introducing means.

40. The cassette of claim 39, wherein the fitting means have a nipple chamber, which is adjacent to a first end of the channel, for receiving the nipple.

41. The cassette of claim 40, wherein the channel is formed on the same cassette side as the nipple chamber.

42. The cassette of claim 39, wherein the nipple chamber is formed in the second cassette side and has a flange to impede the nipple from coming out of the nipple chamber.

43. The cassette of claim 39, wherein the force-introducing means can be laid from the passage opening to a second end of the channel.

44. The cassette of claim 43, wherein the passage opening is adjacent to the second end of the channel.

45. The cassette of claim 26, wherein the fitting means are designed in such a manner that alternating bends on a force-introducing means fitted on the cassette are avoided.

46. A driver of a track-controlled window winder mechanism which has a slider and a cassette operatively connected to the slider, wherein the cassette has fitting means for fitting force-introducing means on the cassette, wherein
the fitting means have a passage opening which completely penetrates the cassette from a first cassette side to a second cassette side, and
the force-introducing means, which is passed through the passage opening, can be fitted on the cassette by the fitting means.

47. The driver of claim 46, wherein the driver has a force-removing means, in particular a stepped bolt, which transmits forces acting on the cassette to a support plate for a window which is to be moved, and on which the slider is fitted.

48. A window winder with a driver as claimed in claim 47, which has a track for controlling the displacement movement of the driver by means of the slider of the driver, which slider is arranged on the track, and a force-introducing means for transmitting a force of a displacement drive of the window winder to the cassette.

49. The window winder of claim 48, wherein the force-introducing means is designed as a cable pull with a cable pull nipple, the cable pull being passed, with the cable pull nipple in front, through the passage opening of the cassette, being laid along a channel of the cassette and the cable pull nipple being fitted in a nipple chamber of the cassette.

50. The window winder of claim 49, wherein the cable pull nipple has a spring mechanism which is fitted in the nipple chamber in such a manner that the spring force of the spring mechanism acts counter to a tensile force transmitted to the driver via the cable pull.
